(19) United States
(12) Patent Application Publication
(10) Pub. No.: US 2025/0296497 A1
(43) Pub. Date: Sep. 25, 2025

(54) MOVABLE MAINTENANCE WORKSHOP FOR VEHICLES

(71) Applicant: KNDS FRANCE, Versailles (FR)

(72) Inventor: Christophe CZORNY, Bourges (FR)

(73) Assignee: KNDS FRANCE, Versailles (FR)

(21) Appl. No.: 19/086,608

(22) Filed: Mar. 21, 2025

(30) Foreign Application Priority Data
Mar. 25, 2024 (FR) 2402888

(51) Int. Cl. B60P 3/14; B60R 16/033; B60R 16/08; B66C 23/04

(52) U.S. Cl. CPC B60P 3/14; B60R 16/033; B60R 16/08; B66C 23/04

(57) ABSTRACT

The invention relates to a mobile maintenance workshop for vehicles, which comprises a base-floor, two side walls and a roof, at least one of the side walls being hinged relative to the base-floor so as to be movable between a raised position and a lowered position. According to the invention, the roof is hinged relative to at least one movable side wall so as to be movable between a folded position and an unfolded position, in which the roof forms at least one access ramp to the platform in the lowered position of said associated movable side wall.

The technical field of the invention is that of mechanical interventions, such as maintenance and repair, on all motorized vehicles in all locations.

The present invention relates to a workshop that can be placed in a transport mode and in a use mode, in particular a vehicle maintenance workshop at least part of which, in the transport mode, is in the general form of a container, e.g. with the dimensions of an ISO standard sea container, capable of changing from a folded configuration for transport to a deployed configuration for use as a maintenance environment, and vice versa.

The workshop according to the present invention will find its application particularly, but not exclusively, in the military field.

In the military field, many environments are known that can be transported in containers of standardized dimensions and deployed from these containers. Such environments can be used as shelters, offices, living quarters, field hospitals and so on. In their folded configuration, these containers can be easily transported by any suitable transport mode. When placed at their place of use, such containers can be opened and deployed to define a space larger than the volume of the container itself. For this purpose, the container generally comprises movable walls.

For example, European patent EP2376351 B1 discloses a portable folding shelter comprising a rigid container, at least one side wall of which is pivotally mounted with joints to pivot between a closed vertical position and an open horizontal position. In said open horizontal position, the at least one side wall increases the floor area. In addition, the container comprises telescopic corner elements that support the roof and are able to slide between lowered and extended positions. In said extended position, the height of the container is increased. The one or more side walls are lowered and raised by means of a manual or electric winch attached to a fixed wall of the container, by winding or releasing a cable attached to the corners of the one or more side walls.

However, in the deployed state, this container does not offer a working area compatible with the reception of a wheeled vehicle ranging from a light car to a heavy tank. In addition, this container requires the external installation of means dedicated to vehicle maintenance, such as lifting means.

The aim of the invention is therefore to provide a workshop which, in the transport mode, can be easily transported, for example like a standard container, and which, in the use mode, can offer a work platform compatible with wheeled vehicles ranging from a light car to a tracked tank, in other words, offering sufficient overhead space for access by a tank-type vehicle and sufficient ground surface area for receiving and circulating around a vehicle, while providing a stable healthy floor that avoids sinking and working directly from the ground. Another aim of the invention is to provide a movable workshop with all the equipment dedicated to and necessary for vehicle maintenance. Yet Y another aim of the invention is to provide a method for installing such a workshop, making it possible to dispense with the installation of deployment means purely dedicated to the deployment of movable walls, and thus to obtain such a workshop quickly and easily.

The invention relates to a movable maintenance workshop for vehicles comprising a base-floor, two side walls and a roof, wherein at least one of the side walls is hinged relative to the base-floor along their common edge so as to be movable between a raised position in which it extends in a plane perpendicular to said base-floor, and a lowered position in which it extends in line said base-floor, in the plane of said base-floor, so as to constitute with the base-floor a platform, the workshop thus being able to be placed in a closed configuration, in which the two side walls extend in a plane perpendicular to said base-floor and the roof extends in a plane parallel to said base-floor, and in a deployed configuration, in which said at least one side wall is in a lowered position, the workshop being characterized in that the roof is hinged relative to at least one movable side wall along their common edge so as to be movable between at least two positions, namely a folded position, in which it extends in a plane parallel to said base-floor in the raised position of said associated movable side wall, the workshop then being in a closed configuration, and an unfolded position, in which the roof forms at least one access ramp to the platform in the lowered position of said associated movable side wall, the workshop then being in an unfolded configuration, the joint between the roof and the at least one movable side wall allowing pivoting with an angle greater than 90 degrees between the folded position and the unfolded position.

Thus, in the closed configuration of the workshop, the workshop retains a small footprint and is easy to move or transport. In the deployed configuration of the workshop, the one or more movable walls form an extension of the base-floor constituting a flat platform, and the roof is able to occupy an inclined position relative to this flat platform in order to constitute an access ramp. As a result, in this deployed configuration, the workshop provides a working area large enough to receive a heavy tank-type vehicle, i.e. a vehicle with significant dimensions in height and width, and to work on it, safely for the operators, and avoiding any work directly from the ground. In addition, such a workshop can be quickly installed and converted between closed and deployed configurations.

Preferably, the at least one movable side wall is hinged to the base-floor and the roof is hinged to the one or more movable side walls.

Preferably, the workshop further comprises at least one end portion, extending perpendicularly from the base-floor, at a respective end of the latter, and a single handling device carried by the base-floor and attached to the base-floor in the vicinity of an end wall, the handling device being contained within the workshop volume in the closed configuration, the handling device being further configured to be able to intervene on a vehicle received on the platform in the deployed configuration of the workshop, and the workshop and the handling device being further configured to enable the handling device to also ensure the mobility of the workshop between said closed configuration and said deployed configuration. The above-mentioned configurations for the handling device and the workshop mainly consist in their dimensioning and the positioning of the handling device on the base-floor, for example near an end wall.

As a result, a single device is required to ensure both the movement of the workshop's movable parts and the handling associated with vehicle maintenance. The result is a smaller footprint of the working area in the deployed configuration, space saving in the closed configuration, and cost savings. In particular, such a device avoids the need for several power-assistance or force-balancing devices for the hinged walls and roof.

Preferably, the handling device is a folding crane, wherein a lateral space is formed between a movable side wall and the end wall located in the vicinity of the crane in the closed configuration of the workshop, and an upper space is formed between the roof and the end wall located in the vicinity of the crane in the closed configuration of the workshop, said lateral and upper spaces enabling the crane to be deployed in the closed configuration of the workshop.

Advantageously, to ensure the safety of operators and equipment, the crane is a folding crane with automatic folding and deployment.

Preferably, the crane comprises a folding mast and a telescopic boom.

Advantageously, the folding mast comprises a mast foot hinged about a horizontal axis on a rotating frame carried by a vertical pivot integral with the base-floor, and a mast head hinged about a horizontal axis at the end of the mast foot, and the telescopic boom comprises a boom foot hinged about a horizontal axis at the end of the mast head and a boom tip slidably mounted in the boom foot, a first jack being hinged between the mast foot and the mast head and a second jack being hinged between the mast head and the boom foot.

Advantageously, a lifting member adapted to receive a crane sling, such as lifting rings, is provided at one or each non-hinged edge of a hinged part of the container.

Preferably, removable or foldable complementary panels fill the lateral space and the upper space in the deployed configuration of the workshop, such that the edges perpendicular to the hinged edges are straight edges. The working area thus obtained does not present a safety risk for operators. It is emphasized here that said lateral and upper spaces will be limited to what is strictly necessary for the deployment of the handling device and any potential stabilizers.

In a particular embodiment, the workshop comprises two end walls fixedly mounted relative to the base-floor, two movable side walls hinged to the long sides of the base-floor and each able to assume said raised position or said lowered position, wherein the roof is defined by two roof panels, each roof panel being hinged to the long side opposite the long side hinged to the base-floor of one of the movable side walls and being able to assume said folded position or said unfolded position.

Such a configuration provides a platform, consisting of the base-floor and the two side walls in the lowered position, large enough to accommodate a large vehicle, and two access ramps to the platform, consisting of the two roof panels in the unfolded position, enabling a vehicle to enter via one of the ramps and exit via the other ramp.

In a variant, the workshop could comprise a single movable side wall and a single roof panel. In another variant, the workshop could comprise two movable side walls and a single roof panel.

Advantageously, the two roof panels are configured such that, in the closed configuration of the workshop, an overlap area is formed between the two roof panels.

Advantageously, for the or each roof panel, the face facing away from the ground in the deployed configuration of the workshop is inclined towards the ground. Thus, in the unfolded position, the or each roof panel is intended to form an inclined access ramp between the ground and the platform.

Preferably, in the lowered position, the one or more movable side walls are carried by leveling means arranged between the or each movable side wall and the ground in order to ensure that the one or more side walls lowered to the same height as the base-floor are held in cantilever. Such leveling means provide a stable platform.

Advantageously, the leveling means are arranged in the region of the two hinged edges of the one or more movable walls, namely the edge hinged to the base-floor and the edge hinged to the roof.

The leveling means may comprise attached support plates, the leveling being obtained by stacking support plates.

Alternatively, the leveling means may comprise attached support plates integral with telescopic jacks, in particular screw jacks. In another variant, the leveling means may comprise telescopic jacks, in particular screw jacks, carried by the or each movable side wall and housed in the thickness of the panel defining said wall, each jack being able to carry a retractable foot arranged to come into contact with the ground. In these variants, leveling is achieved by adjusting the telescopic jacks.

In yet another variant, the leveling means may comprise hydraulic jacks housed in the thickness of the panel defining the or each movable side wall. In this variant, leveling can be achieved automatically, with possible leveling by an operator and external means, such as a bubble level.

It should also be noted that it will be advantageously possible to manually level the access ramps, for example using shims, particularly in order to extend the horizontal zone if necessary.

Preferably, the workshop contains, in the closed configuration, at least one piece of equipment dedicated to vehicle maintenance, wherein said equipment is carried by the base-floor in the closed configuration of the workshop. The presence of on-board equipment makes it possible to transport both the structure and the equipment required for vehicle maintenance.

Advantageously, in the deployed configuration of the workshop, the platform and the one or more access ramps have two reinforced rolling bands allowing the circulation of heavy vehicles, in particular up to 50 tons.

Preferably, for optimum use of the workshop and compliance with waste disposal regulations, the workshop includes a used fluid storage means housed in the thickness of a panel defining a movable side wall.

Preferably, the workshop comprises a power supply means, in particular for the handling device, at least partly housed in the thickness of a panel defining an end wall.

The used fluid storage means may comprise at least one tank.

The power supply means may include at least one battery and the electronics required to operate the workshop.

Preferably, the workshop, in the closed configuration, is in the general form of an ISO standard transport container, such as a twenty-foot-long High Cube or standard sea container, in particular ISO668 1CCC or 1CC, with the base-floor having corner pieces at its four corners. In the closed configuration, the workshop can thus be transported like a conventional container.

The workshop can then advantageously comprise a cradle, which in particular comprises two rails integral with a lower face of the base-floor and projecting therefrom at a first end of the rails, a two-armed pillar extending from said first ends of the rails, a gripping hook integral with the pillar, and two depositing rollers each located in the vicinity of a second end of a respective rail. The cradle may advantageously comply with the STANAG 2413 standard.

Alternatively, the workshop could simply be fitted, for example on the outer face of an end wall, with a cradle-type gripping pin to enable the workshop to be handled, in the closed configuration, with the same means as those already commonly used for conventional containers.

According to another embodiment, the workshop comprises a rolling frame, one main part of which is lowered relative to two end parts carrying rolling means, the base-floor being fixed to said main part.

The rolling frame could be of the type of a rolling trailer, the rolling means being formed, at a first end part, by at least one axle and, at the second end part, by a gooseneck for coupling to a motorized vehicle. In other words, the present invention could then be considered to be a rolling trailer equipped with a vehicle maintenance workshop.

Alternatively, the rolling frame could be of the type used for a motorized vehicle, including engine means, cab, etc. In other words, the present invention could then be considered to be a motorized vehicle, such a truck, equipped with a vehicle maintenance workshop.

In both cases, the workshop, in its closed configuration, can then be easily transported by a motorized vehicle. It should be emphasized here that the presence of end walls is also optional.

The invention will be better understood upon reading the following description, made in reference to the appended drawings, in which:

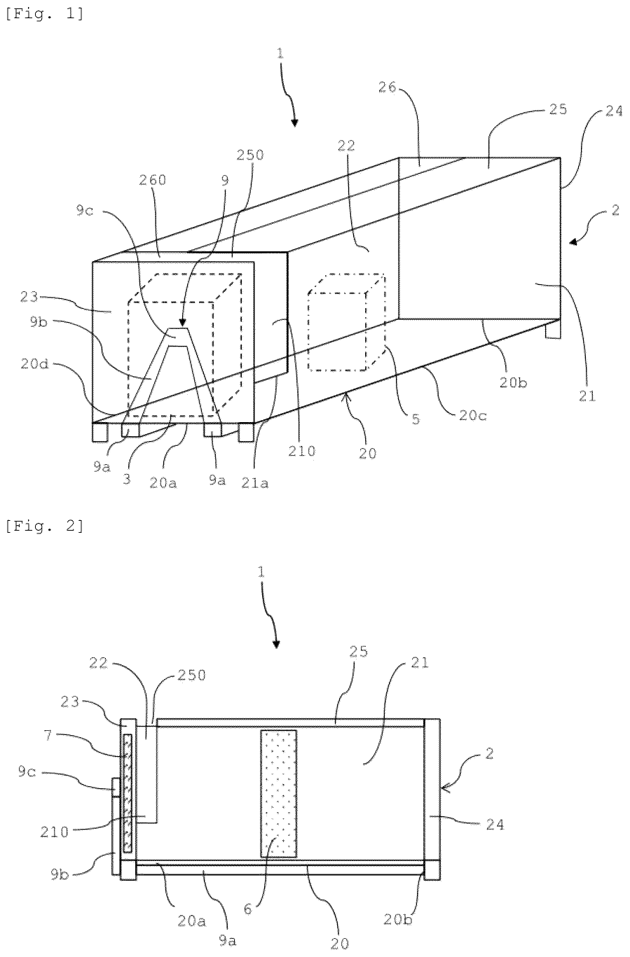

FIG. 1 shows a schematic perspective view of the maintenance workshop according to a first particular embodiment of the invention, in the closed configuration;

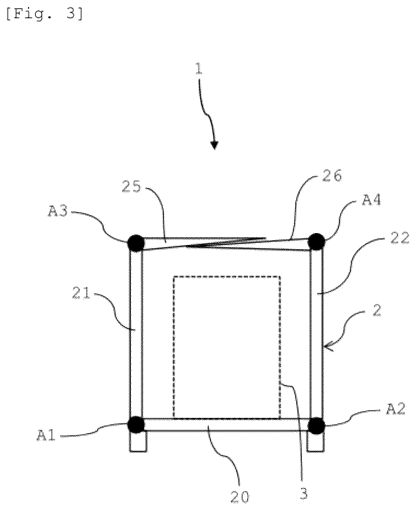

FIG. 2 shows a schematic longitudinal side view of the workshop shown in FIG. 1, in the closed configuration;

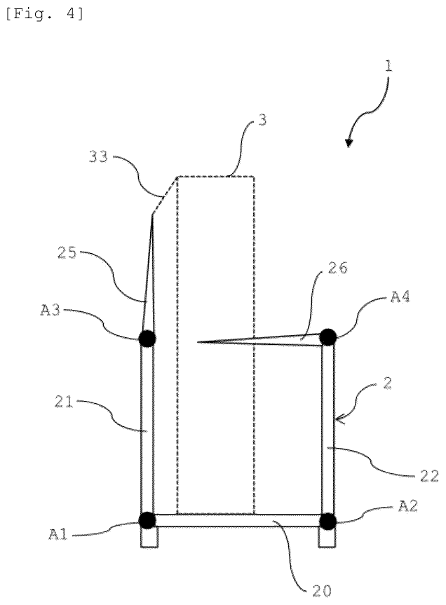

FIG. 3 shows a schematic transverse side view, or front view, of the workshop of FIG. 1, in the closed configuration, with the end walls and cradle omitted;

FIG. 4 shows a schematic cross-sectional side view of the workshop of FIG. 3, during an installation step, after the crane has been deployed;

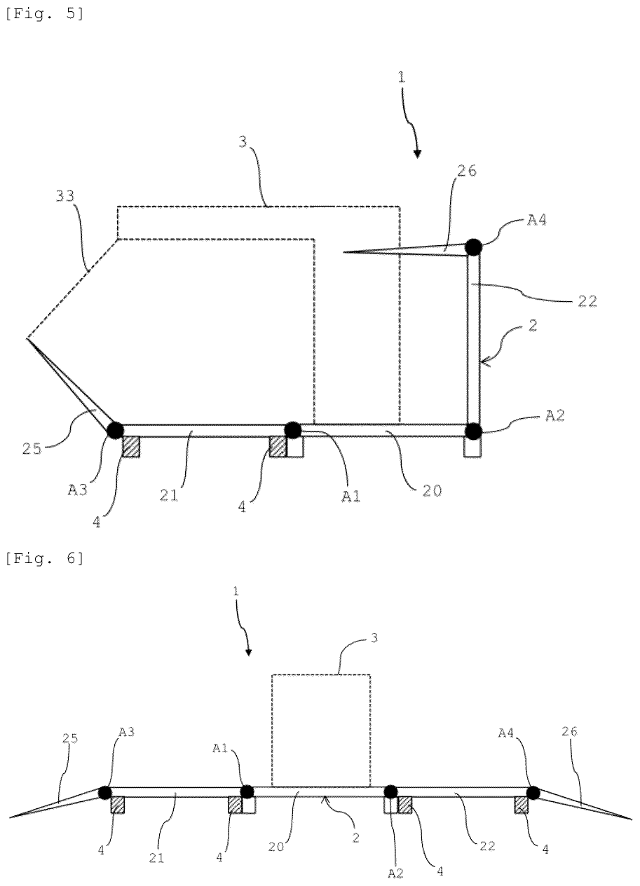

FIG. 5 corresponds to a later step than FIG. 4;

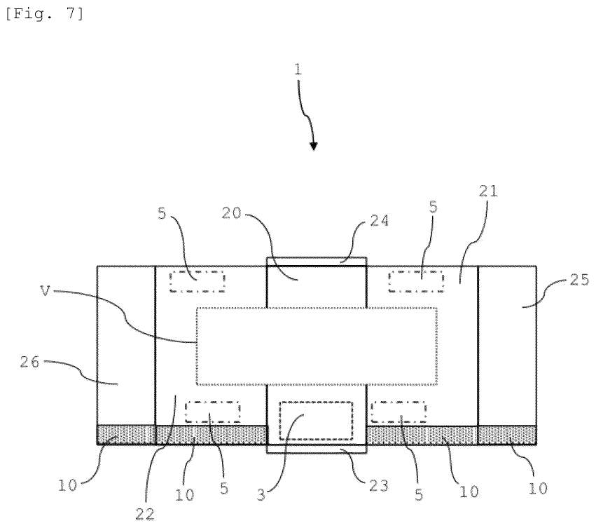

FIG. 6 shows the workshop of FIG. 3 in the deployed configuration;

FIG. 7 is a schematic top view of the workshop of FIG. 1, in the deployed configuration and in use;

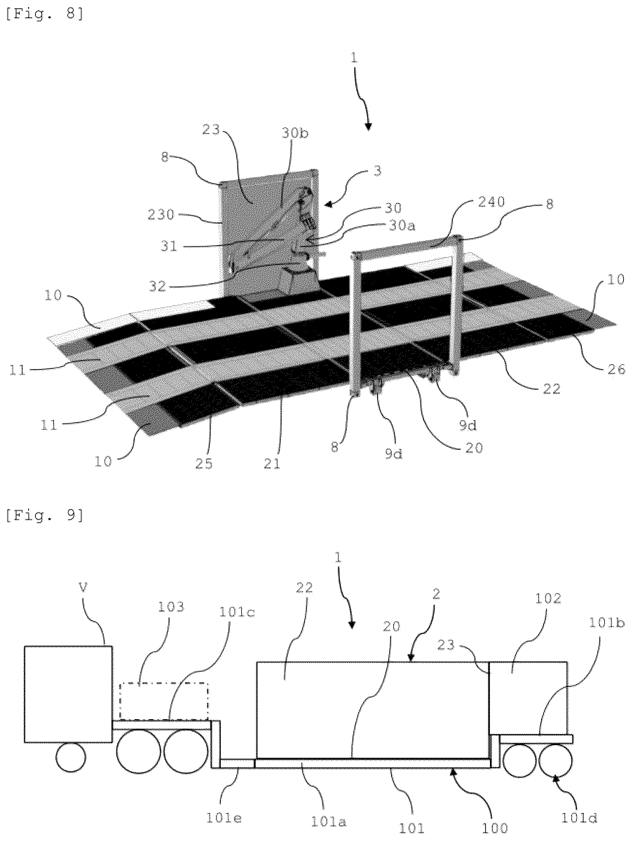

FIG. 8 is a perspective view of the workshop of FIG. 1, in the deployed configuration, showing the platform and the access ramps;

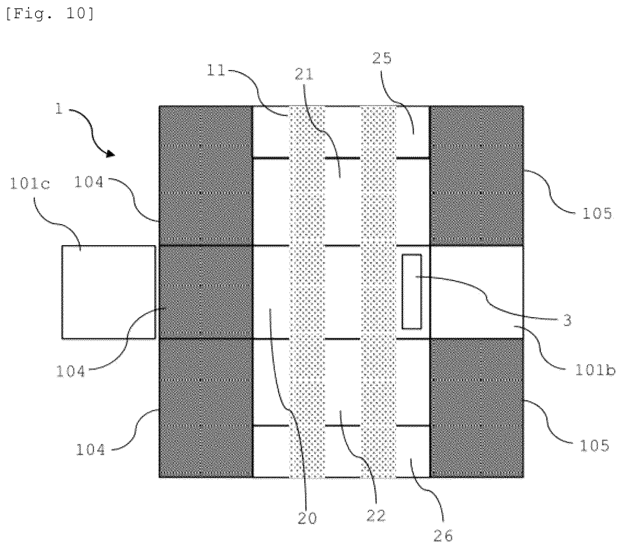

FIG. 9 is a schematic side view of the maintenance workshop according to a second embodiment of the invention, in the process of extending the rolling frame; and

FIG. 10 is a schematic top view of the workshop of FIG. 9, in the deployed configuration.

The movable maintenance workshop 1 for vehicles V according to the invention is intended to be transported to a desired location, in particular close to operating areas, and to be rapidly deployed in order to accommodate any type of vehicle V, i.e. a light vehicle as well as a tracked tank, to enable maintenance operations to be carried out.

In the first embodiment shown in FIGS. 1 to 8, the workshop 1 is, in a closed configuration, in the general form of a transportable container 2 and comprises a single handling device 3, leveling means 4, at least one piece of equipment 5 dedicated to the maintenance of vehicles V, a used fluid storage means 6 and a power supply means 7.

Referring to FIGS. 1 to 3, it can be seen that, in a closed configuration, the workshop 1 is in the general form of a hollow, rigid, parallelepiped-shaped container 2. If referring to FIGS. 6 to 8, it can be seen that, in a ready-for-use state of the workshop 1, the workshop 1 is in a deployed configuration. The workshop 1 is therefore able to switch from the closed configuration to the deployed configuration, and vice versa.

In the closed configuration, the workshop 1 has standard dimensions, i.e. dimensions meeting ISO international standards for container transport and handling, or dimensions approaching those of a standard-sized container. The workshop 1 comprises a base-floor 20, two side walls 21, 22, two end walls 23, 24 and a roof 25, 26. More particularly, in the preferred embodiment shown, the workshop 1 comprises a base-floor 20, two pivoting side walls 21, 22, two end walls 23, 24 fixed relative to the base-floor 20, and a roof 25, 26 made of two pivoting parts. Alternatively, the workshop 1 could comprise a single pivoting side wall and/or a single-piece pivoting roof.

The base-floor 20 comprises a rectangular-shaped panel with a front longitudinal end 20a, a rear longitudinal end 20b, a left edge 20c and a right edge 20d. The left 20c and right 20d edges correspond to the long sides of the panel, while the front 20a and rear 20b longitudinal ends correspond to the short sides of the panel. The panel has an inner face and an opposite outer face.

Each end wall 23, 24 comprises a rectangular-shaped panel integral with a reinforcing frame 230, 240, the reinforcing frames 230, 240 being shown in FIG. 8. One of the end walls 23, referred to as the front wall 23, is integral with the front longitudinal end 20a, while the other end wall 24, referred to as the rear wall 24, is integral with the rear longitudinal end 20b. The front wall 23 and rear wall 24 face each other. Each frame 230, 240 has two vertical uprights connected at their upper end by an upper crosspiece. At their four corners, i.e. at the upper and lower ends of the uprights, each end wall 23, 24 has a standard corner element 8 with standardized openings on all its visible faces, particularly for gripping by handling devices. These corner elements 8, shown in FIG. 8, are known per se.

Preferably, the workshop 1 is also equipped with a cradle 9 to facilitate handling thereof. The cradle 9 comprises two longitudinal rails 9a, parallel to the longitudinal direction of the base-floor 2 and integral with the lower face of the latter. The rails 9a protrude from the base-floor 2 at a first end, from which a two-armed pillar 9b extends, which is located in the vicinity of an outer face of the end wall 23 and which carries at its upper part a gripping hook 9c preferably complying with STANAG 2413 standard. The cradle 9 also comprises two depositing rollers 9d (FIG. 8), each located in the vicinity of a second end of a respective rail 9a, the depositing rollers 9d here being rotatably carried directly by the base-floor 2. The cradle 9 enables the workshop 1, in the closed configuration, to be placed on a transport means (not shown), such as a container truck, and then deposited on the ground for use.

Of course, this gripping hook 9c can be replaced with any other suitable anchoring and/or lifting means, such as those complying with NF R17-107 and NF R17-108 standards for civil applications.

In the case of electric motorization of the handling device 3, the power supply means 7 can be housed in the thickness of the panel of the front wall 23, as shown in FIG. 2. This means may include batteries and the electronics required to operate the handling device 3.

Each side wall 21, 22 comprises a panel which is connected to an edge 20c, 20d of the base-floor 20 and is pivotally mounted about a joint axis A1, A2 parallel to the common edge between the wall 21, 22 and the base-floor 20. This panel has two opposite long sides and two opposite short sides. The length of the long side corresponding to the edge connected to the base-floor 20 is the same length as each of the left 20c and right 20d edges to which it is connected. One of the two panels, i.e. the panel of one of the two side walls 21, 22, for example, of the wall 21 connected to the left edge 20c of the base-floor 20, has an edge opposite the edge connected to the base-floor 20 with a length shorter than that of the edge connected to the base-floor 20 and a stepped edge corresponding to one of its short sides, such that a rectangular recessed area 21a is formed in a corner region of this panel. In the raised position of the side wall 21, this recessed area 21a creates a vertical lateral space 210 between the end wall 23 adjacent to this recessed area 21a and said side wall panel 21. The other panel has two short sides of the same length, substantially equal to the length of each vertical upright, and two long sides of the same length.

The long side, i.e. the lower edge side, of each panel is pivotally coupled to the base-floor 20 by a joint A1, A2 provided between each side wall 21, 22 and the base-floor 20 in order to move from a raised vertical position, perpendicular to the base-floor 20, to a lowered horizontal position, coplanar with the base-floor 20. In this way, the two joints A1, A2 each allow a rotation of the order of ninety degrees. In other words, each joint A1, A2 is such that, after the panel has been rotated outwards by 90 degrees, its inner face is flush with the inner face of the base-floor 20. Each joint A1, A2 is preferably a hinge joint. It should be emphasized that the movable side walls 21, 22 are connected to the base-floor 20 solely by these joints A1, A2, no means for moving the movable walls 21, 22 connecting the movable walls 21, 22 to the base-floor 20.

Advantageously, in order to ensure waste disposal, the used fluid storage means 6 is housed in the thickness of the panel of one of the two side walls 21, 22, in particular the wall 21 connected to the left edge 20c of the base-floor 20 and having the recessed area 21a, as shown in FIG. 2. This means 6 may comprise one or more storage tanks. These tanks can be positioned centrally with respect to the panel, considering the longitudinal direction of the panel. Access to the one or more tanks may be provided on the inner face of the panel, which will therefore form part of the surface of the working platform area in the deployed configuration, with the discharge taking place via a plug located at the bottom of the tank when the workshop 1 is in the deployed configuration. Advantageously, the plug is accessible when the workshop 1, in the closed configuration, is located on a carrier vehicle.

FIG. 5 shows the side wall 21 having the recessed area 21a in the lowered position. In this lowered position, it rests on leveling means 4. These means 4 are positioned or moved in the space formed between the ground and the side wall 21 when the inner face of the panel is located in the same plane as the inner face of the base-floor 20. In this way, these means 4 ensure that a flat and stable platform is formed, which platform is formed by the inner face of the base-floor 20 and the inner face of each side wall 21, 22 in the lowered position. Similarly, as it can be seen in FIG. 6, once the other side wall 22 has been placed in the lowered position, it also rests on the leveling means 4. Preferably, each side wall 21, 22 is leveled by four leveling means 4 arranged at its four corners. Each leveling means 4 can be at least one element attached and/or an element integrated to the panel. In the case of an attached element, this may be several support plates stacked one on top of the other and/or a support plate carrying a screw jack. The number of support plates to be stacked and/or the setting of the screw jack is then estimated by the operator using an external tool, such as a gauge or laser level. In the case of a panel-integrated element, this may be a screw jack housed in the thickness of the panel, or a hydraulic jack housed in the thickness of the panel. In the case of hydraulic jacks, the stroke of the jacks is automatically adjusted via a system integrated into the container 2.

The roof 25, 26 is defined by first 25 and second 26 rectangular roof panels. Each roof panel 25, 26 is hinged to one of the side walls 21, 22 and is pivotally mounted about a joint axis A3, A4 parallel to the common edge between the side wall 21, 22 and the roof panel 25, 26. Thus, each roof panel 25, 26 has a hinged edge, a free edge opposite the hinged edge, and two side edges. In cross-section, each roof panel 25, 26 has a triangular cross-section, in particular a right-angled triangle. The right angle of this right-angled triangle is formed between the hinged edge and the outward-facing face in the folded position. The hypotenuse of this right-angled triangle is formed by the inward-facing face of the container 2 in the folded position. The length of the hinged edge is equal to the length of the free edge, which corresponds to the length of the longitudinal edge, connected to the roof panel 25, of the side wall 21 containing the recessed area. Thus, in the closed configuration of the container 2, an upper space 250, 260 is formed between the roof 25, 26 and the front end wall 23, over the entire width of the end wall 23.

In the closed configuration, the horizontal upper space 250, 260 and the vertical lateral space 210 together delimit a space sufficient to allow the deployment of the handling device 3.

Each side edge has a length greater than half the width of each end wall 23, 24. Thus, in the closed configuration, one of the roof panels, in particular the first panel 25, overlaps the free edge region of the other roof panel, in particular the second roof panel 26. This overlap area ensures watertightness in the closed configuration.

The joint A3, A4 between each roof panel 25, 26 and the corresponding side wall 21, 22 can be a hinge-type joint. This joint A3, A4 allows rotation with an angle greater than 90 degrees about the joint axis A3, A4, which axis A3, A4 is parallel to the joint axis A1, A2 between the base-floor 20 and each side wall 21, 22. In other words, rotation with an angle greater than 90 degrees between the roof panel 25, 26 and the associated side wall 21, 22 is possible.

In this way, each roof panel 25, 26 is able to assume a folded position, in which it extends substantially perpendicular to the side wall 21, 22, i.e. substantially horizontally when the side wall 21, 22 is in the raised position, and an unfolded position, in which it extends at an angle greater than 180 degrees relative to the side wall 21, 22 in the lowered position, and in an inclined manner between the platform and the ground. In this unfolded position, each roof panel 25, 26 forms an access ramp to the platform, facilitating access, i.e. entry and exit, for vehicles V, as shown in FIG. 8. If required, the access ramps can also be manually leveled, for example using shims.

FIGS. 7 and 8 show the two side walls 21, 22 placed in the lowered position and the two roof panels 25, 26 placed in the unfolded position. These positions define the deployed configuration of the workshop 1, in which removable complementary panels 10 are added to obtain a rectangular working area, i.e. a platform 20, 21, 22 and ramps 25, 26 of equal length in the longitudinal direction of the base-floor 20. In particular, a complementary panel 10 fills the recessed area 21a and two complementary panels 10 extend each of the two roof panels 25, 26, such that the edge of the platform and ramps on the front wall 23 side is a straight edge. The upward-facing face of each complementary panel 10 is flush with the upward-facing face of the panel to which it is connected. Alternatively, one or each of the complementary panels 10 could be a folding panel, pivotally mounted with respect to the edge of the panel to which it is connected, and capable of being folded against the panel carrying it. As it can be seen in FIG. 8, further complementary panels 10 can be installed at the edge opposite the hinged edge of each roof panel 25, 26. Such an extension of the ramps could make it possible to reduce the inclination of the ramps and thus advantageously facilitate access to the platform by the vehicles V. The complementary panels 10 can be attached to the side walls 21, 22 and the roof panels 25, 26, for example by screws and tappings provided in the roof panels 25, 26, or strapped to the base-floor 20.

As it can be seen in the Figures, the workshop 1 comprises a single handling device 3, such as a folding crane 3, both for the mobility of the movable panels 21, 22, 25, 26 and for the maintenance and/or repair of the vehicles V. This crane 3 is carried by the base-floor 20 and is integral with its inner face, in the vicinity of the front longitudinal end 20a. The crane 3 is permanently installed on the base-floor 20. In the closed configuration, the crane 3 faces the lateral space 210 and the upper space 250, 260.

For added safety, the crane 3 can also be automatically folded and deployed. In this case, as shown in FIG. 8, the crane 3 comprises a foldable mast 30 and a telescopic boom 31. The foldable mast 30 comprises a mast foot 30a hinged about a horizontal axis on a rotating frame 32 carried by a vertical pivot integral with the base-floor 20, and a mast head 30b hinged about a horizontal axis at the end of the mast foot 30a, and the telescopic boom 31 comprises a boom foot hinged about a horizontal axis at the end of the mast head 30b and a boom tip slidably mounted in the boom foot, a first jack being hinged between the mast foot 30a and the mast head 30b and a second jack being hinged between the mast head 30b and the boom foot. For panel mobility, the crane 3 comprises slings 33 connected to the boom tip. Each sling 33 is able to be connected to a lifting member, such as lifting rings, provided at one or each free edge of a movable panel.

Each panel is sufficiently rigid to carry the equipment 5 dedicated to the maintenance of vehicles V and to walk on the panel. As it can be e seen in FIG. 1, in the closed configuration, this equipment 5 is carried by the base-floor 20. As it can be seen in FIG. 7, in the deployed configuration, this equipment 5 is placed at desired locations on the platform and ramps. Thus, the workshop 1 according to the present invention contains all the means necessary for the maintenance of all types of motorized vehicles V.

In the deployed configuration of the workshop 1, the face of the platform and the access ramps intended to come into contact with the vehicles V has two reinforced rolling bands 11 allowing the circulation of heavy vehicles, in particular up to 50 tons. As it can be seen in FIG. 8, these bands 11 are parallel to each other and spaced apart by a distance corresponding to the distance between the rolling means of a heavy vehicle. Each band 11 is continuous from the free edge of one ramp to the free edge of the opposite ramp, in a direction orthogonal to the joint axes A1-A4. The surface not comprising the two reinforced bands 11 is designed to allow the movement of a pallet truck of sufficient capacity to handle the equipment required for repairing heavy vehicles.

Setting up the workshop 1 from the closed configuration (FIGS. 1-3) to the deployed configuration (FIGS. 6-8) is quick and easy. First, the crane 3 is deployed, possibly automatically. Once deployed, the mast head 30b and the boom 31 are positioned above the roof 25, 26, after passing through the lateral space 210 and the upper space 250, 260. The roof 25, 26 is then slung, with the slings 33 connected at the two corners of the free edge of the first roof panel 25. The operator then actuates the lifting of the first roof panel 25, as shown in FIG. 4. This first roof panel 25 and the associated first side wall 21 are moved, by rotational movements of the crane 3 and the control of its jacks, until the first side wall 21 is deposited on the ground, as shown in FIG. 5. The leveling means 4 are then installed and/or adjusted between the first side wall 21 in its lowered position and the ground, to achieve the desired stability. The first roof panel 25 is then placed on the ground to form a first access ramp. These steps are then repeated for the second roof panel 26 and the associated second side wall 22. Once the side walls 21, 22 have been lowered and wedged in place by the leveling means 4, and the roof panels 25, 26 are in the unfolded position, the complementary panels 10 and the maintenance equipment 5 are installed. The workshop 1 is then ready to receive a vehicle V to be serviced and/or repaired, as schematically shown in FIG. 7.

Conversely, when the movable workshop 1 is to be moved to another site, the workshop 1 switches from the deployed configuration to the closed configuration by implementing the above steps in reverse order. The workshop 1 in the closed configuration, containing the single handling device 3 as well as all the equipment 5, the complementary panels 10 and the leveling means 4, can be easily transported to the desired site.

The workshop 1 according to the first embodiment above is transportable like a conventional container.

Referring now to FIGS. 9 and 10, it can be seen that the workshop 1 is shown according to a second embodiment, which differs from that described above in that it does not comprise a cradle 9 and incorporates instead a rolling frame 101. Thus, only those parts which differ from the first embodiment will be described below.

In the example shown in FIGS. 9 and 10, the rolling frame 101 is that of a trailer 100, for example of the conventional low bed trailer type. In particular, the rolling frame 101 comprises a main part 101a, between two end parts, a first part 101b of which carries two axles, and a second part 101c of which is gooseneck-shaped for coupling to a motorized vehicle V, not forming part of the trailer 100. The axles and the gooseneck-shaped part form rolling means 101d, in that they enable the trailer 100 to roll.

The main part 101a is lowered relative to the end parts 101b, 101c, so as to be close to the ground. The base-floor 20 is mounted on the main part 101a and is attached to it, whether removably or not, by any suitable means.

In particular, the base-floor 2a is oriented such that the handling device 3 is located on the first end part 101b side, and at least one end wall 23 will be advantageously provided, extending from the base-floor 20, in the vicinity of said first end part 101b.

In the illustrated example, the rolling frame 101 is telescopic, which is optional, and the main part 101a is slidably mounted on a guide rail 101e, the movement of the main part 101a being controlled by any suitable means, as is well known, such as by a rack system.

A second end wall may be omitted on the second end part 101c side. However, it would also be possible to provide a second end wall rotatably mounted, for example with hinge, to the base-floor 20, such that it can be lowered in the plane of the base-floor 20 in the deployed configuration of the workshop 1. As the workshop 1 is transported here by towing, the corner elements 8 are not needed, so reinforcing frames 230, 240 can be omitted.

The first and second end parts 101b, 101c also constitute additional support regions that enable additional equipment 102 to be carried, for example on the first end part 101b, and electrical, hydraulic and/or pneumatic equipment 103 required for deployment and/or use of the workshop 1 to be positioned, for example on the second end part 101c.

The workshop 1 is placed in the closed configuration or in the deployed configuration in the same way as described above.

In the closed configuration shown in FIG. 9, the workshop 1 can be transported on the road by a motorized towing vehicle, in the manner of a conventional trailer. In other words, the workshop according to the invention can be considered as a rolling trailer equipped with a vehicle maintenance workshop.

In the deployed configuration, shown in FIG. 10, the base-floor 20, the side walls 21, 22, the roof panels 25, 26 and the complementary panels form the working platform, which can here be further completed by additional removable panels 104 placed in the space created by the extension of the rolling frame 101, as well as by additional panels 105 placed on both sides of the second end part 101b of the rolling frame 101.

Naturally, manual or non-manual leveling means can be provided for the working platform, such as manual shims, stabilizing jacks, etc., for example carried by the rolling frame 101.

It is understood that the particular embodiments just described are indicative and non-limiting, and that modifications may be made without departing from the present invention.

For example, the rolling frame could be that of a motorized vehicle, and the workshop according to the invention could then be considered to be a motorized vehicle, particularly of the truck type, equipped with a vehicle maintenance workshop.

1-A mobile maintenance workshop for vehicles, the mobile maintenance workshop comprising a base-floor, two side walls and a roof, wherein at least one of the side walls, referred to as movable side wall, is hinged relative to the base-floor along a common edge that is common to the base-floor and said at least one movable side wall, so as to be movable between a raised position in which said at least one movable side wall extends in a plane perpendicular to said base-floor, and a lowered position in which said at least one movable side wall extends in line with said base-floor, in a plane of said base-floor, so as to constitute with the base-floor a platform, the mobile maintenance workshop thus being able to be placed in a closed configuration, in which the two side walls extend in a plane perpendicular to said base-floor and the roof extends in a plane parallel to said base-floor, and in a deployed configuration, in which said at least one hinged side wall is in a lowered position, wherein the roof is hinged relative to at least one movable side wall, referred to as associated movable side wall, along a common edge that is common to the roof and to said at least one associated movable side wall, so as to be movable between at least two positions, namely a folded position, in which the roof extends in a plane parallel to said base-floor in the raised position of said associated movable side wall, the mobile maintenance workshop then being in a closed configuration, and an unfolded position, in which the roof forms at least one access ramp to the platform in the lowered position of said associated movable side wall, the mobile maintenance workshop then being in an deployed configuration, the joint between the roof and the at least one associated movable side wall allowing pivoting with an angle greater than 90 degrees between the folded position and the unfolded position.

2-The mobile maintenance workshop according to claim 1, wherein the mobile maintenance workshop further comprises at least one end portion, extending perpendicularly from the base-floor, at a respective end of the base-floor, and a single handling device carried by the base-floor and attached to the base-floor in a vicinity of an end wall, the handling device being contained within volume of the mobile maintenance workshop in the closed configuration, the handling device being further configured to be able to intervene on a vehicle received on the platform in the deployed configuration of the mobile maintenance workshop, and the mobile maintenance workshop and the handling device being further configured to enable the handling device to also ensure a mobility of the mobile maintenance workshop between said closed configuration and said deployed configuration.

3-The mobile maintenance workshop according to claim 2, wherein the handling device is a folding crane, wherein a lateral space is formed between a movable side wall and the end wall located in a vicinity of the folding crane in the closed configuration of the mobile maintenance workshop and an upper space is formed between the roof and the end wall located in a vicinity of the folding crane in the closed configuration of the mobile maintenance workshop, said lateral and upper spaces enabling the folding crane to be deployed in the closed configuration of the mobile maintenance workshop.

4-The mobile maintenance workshop according to claim 3, wherein removable complementary panels fill the lateral space and the upper space in the deployed configuration of the mobile maintenance workshop, so that the edges perpendicular to the hinged edges are straight edges.

5-The mobile maintenance workshop according to claim 3, wherein foldable complementary panels fill the lateral space and the upper space in the deployed configuration of the mobile maintenance workshop, so that the edges perpendicular to the hinged edges are straight edges.

6-The mobile maintenance workshop according to claim 1, wherein the mobile maintenance workshop comprises two end walls fixedly mounted relative to the base-floor, two movable side walls hinged to long sides of the base-floor and each able to assume said raised position or said lowered position, wherein the roof is defined by two roof panels, each roof panel being hinged to a long side opposite a long side hinged to the base-floor of one of the movable side walls and being able to assume said folded position or said unfolded position.

7-The mobile maintenance workshop according to claim 1, wherein, in the lowered position, the one or more movable side walls is carried by leveling means arranged between the or each movable side wall and a ground in order to ensure that the one or more side walls lowered to a same height as the base-floor are held in cantilever.

8-The mobile maintenance workshop according to claim 1, wherein the mobile maintenance workshop contains, in the closed configuration, at least one piece of equipment dedicated to maintenance of vehicles, wherein said piece of equipment is carried by the base-floor in the closed configuration of the mobile maintenance workshop.

9-The mobile maintenance workshop according to claim 1, wherein the mobile maintenance workshop comprises a used fluid storage means housed in a thickness of a panel defining a movable side wall.

10-The mobile maintenance workshop according to claim 1, wherein the mobile maintenance workshop comprises a power supply means at least partly housed in a thickness of a panel defining an end wall.

11-The mobile maintenance workshop according to claim 1, wherein the mobile maintenance workshop comprises a cradle.

12-The mobile maintenance workshop according to claim 11, wherein the cradle comprises two rails integral with a lower face of the base-floor and projecting from the base-floor at a first end of the rails, a two-armed pillar extending from said first ends of the rails, a gripping hook integral with the pillar, and two depositing rollers each located in a vicinity of a second end of a respective rail.

13-The mobile maintenance workshop according to claim 1, wherein the mobile maintenance workshop comprises a rolling frame, a main part of which is lowered relative to two end parts carrying rolling means, the base-floor being fixed to said main part.
